(19) United States
(12) Patent Application Publication
(10) Pub. No.: US 2024/0165732 A1
(43) Pub. Date: May 23, 2024

(54) WELDABILITY IN RESISTANCE WELDING OF STEELS WITH LARGE DIFFERENCE IN SHEET THICKNESS

(71) Applicant: GM BLOBAL TECHNOLOGY OPERATIONS LLC, Detroit, MI (US)

(72) Inventors: Pei-Chung Wang, Forest Hills, NY (US); Anthony J. DiCocco, Canton, MI (US); Zhenke Teng, Troy, MI (US); Nicholas A. Brizes, Linden, MI (US)

(73) Assignee: GM GLOBAL TECHNOLOGY OPERATIONS LLC, Detroit, MI (US)

(21) Appl. No.: 17/992,317

(22) Filed: Nov. 22, 2022

(51) Int. Cl. B23K 11/00; B23K 11/16; B32B 7/12; B32B 15/01

(52) U.S. Cl. CPC B23K 11/0026; B23K 11/163; B32B 7/12; B32B 15/011; B25J 11/0075

(57) ABSTRACT

A method for resistance welding at least three steel sheets, a weld structure produced by resistance welding at least three steel sheets and a method for determining weldability solutions when resistance welding at least three steel sheets in a stack are provided. By applying a layer of adhesive/sealer material between a thicker outer sheet of steel and an adjacent thicker inner sheet, thereby generating extra heat that increases penetration into a thinner outer sheet but with no layer of adhesive/sealer material between a thinner outer sheet and an adjacent thicker inner sheet, current density drop issues of a current process are addressed.

### INTRODUCTION

The present disclosure is related to resistance welding of steel stack-ups with high-thickness ratio and, specifically, to resistance welding steel sheets with a large difference in gauge.

Current processes for resistance welding steel stack-ups having a high thickness ratio utilize a layer of adhesive/sealer material (ASM) between a thinner outer sheet of steel and a thicker inner sheet of steel to increase heat generation and improve weld penetration. However, such processes are not robust due to a current density drop introduced by the added ASM.

The present disclosure addresses this issue, as well as others, by applying a layer of ASM between a thicker outer sheet of steel and an adjacent thicker inner sheet, thereby generating extra heat that increases penetration into a thinner outer sheet.

### SUMMARY

The present disclosure provides a method for method for resistance welding at least three steel sheets, a weld structure produced by resistance welding at least three steel sheets and a method for determining weldability solutions when resistance welding at least three steel sheets in a stack.

The method for resistance welding at least three steel sheets includes arranging the at least three steel sheets as a stack according to a corresponding thickness of each of the at least three steel sheets such that a thinnest of the at least three steel sheets is an outermost layer of the stack, placing a layer of adhesive/sealer material between at least a thickest two steel sheets of the stack, and resistance welding the stack according to a unified weld schedule such that weld penetration extends into the thinnest of the at least three steel sheets.

The method is further performed if a ratio of the corresponding thickness of any two adjacent steel sheets of the stack is at least 4.3. The layer of adhesive/sealer material is at least adhesive, sealer, or high resistivity metallic coating and may be a combination of at least two of adhesive, sealer, and Al—Si.

The layer of adhesive/sealer material may be placed between more than the thickest two steel sheets of the stack. The weld penetration includes a weld nugget that has a martensitic microstructure zone.

The method may be performed by a system including at least a robotic dispenser configured to dispense a layer of adhesive/sealer material, a robotic material handler configured to arrange the at least three steel sheets, a robotic welder configured to resistance weld the stack, and a processor configured to control the system.

The above summary is not intended to represent every embodiment or every aspect of the present disclosure. Rather, the foregoing summary merely provides an exemplification of some of the novel concepts and features set forth herein. The above features and advantages, and other features and advantages, will be readily apparent from the following detailed description of illustrated embodiments and representative modes for carrying out the disclosure when taken in connection with the accompanying drawings and appended claims. Moreover, the present disclosure expressly includes any and all combinations and sub-combinations of the elements and features presented previously and subsequently.

### BRIEF DESCRIPTION OF THE DRAWINGS

FIG. 1A illustrates a current process for resistance welding of steel stack-ups.

FIG. 1B illustrates a process for resistance welding of steel stack-ups according to an embodiment of the present disclosure.

FIG. 2 illustrates a process to determine one of multiple welding solutions based on a thickness ratio of stacked steel sheets according to an embodiment of the present disclosure.

The present disclosure may be extended to modifications and alternative forms, with representative embodiments illustrated in the drawings and disclosed in detail herein. Inventive aspects of the present disclosure are not limited to the disclosed embodiments. Rather, the present disclosure is intended to cover modifications, equivalents, combinations, and alternatives falling within the scope of the disclosure as defined by the appended claims.

### DETAILED DESCRIPTION

The following description is merely exemplary in nature and is not intended to limit the present disclosure, application, or uses. It should also be understood that throughout the drawings, corresponding reference numerals indicate like or corresponding parts and features.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Current processes for welding three-thickness (3T) steel sheet stack-ups, in which a thickness ratio between any two adjacent sheets of steel is greater than or equal to 3.0, apply a layer of ASM between a thinner outer sheet of steel and a thicker inner sheet of steel and an adjacent thicker inner sheet. However, such processes are not robust due to a current density drop introduced by the added ASM between the thinner outer sheet and adjacent thicker inner sheet.

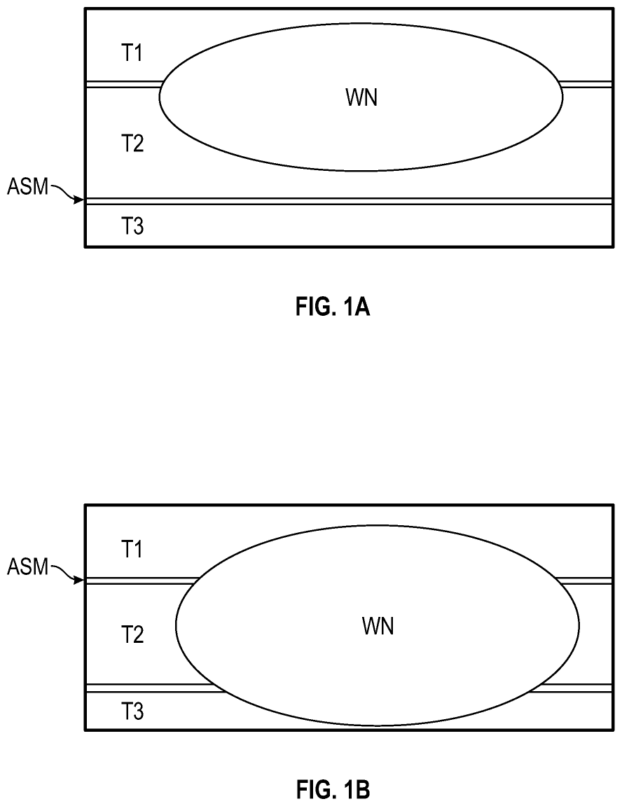

FIG. 1A illustrates a current process for resistance welding of steel stack-ups. As illustrated in FIG. 1A, the current process places the layer of ASM between thinner outer (or bottom) sheet of steel T3 and an adjacent inner (or middle) sheet of steel T2. Due to the low yield strength of the thinner outer sheet material and high rigidity of the applied ASM, the thinner outer sheet wraps around the weld electrodes during welding, causing a current density to drop at the interface between T3 and T2. This results in a weld nugget (WN), which has a martensitic microstructure fusion zone, which doesn't extend deeply enough to penetrate thinner outer layer T3, thereby resulting in little or no weld between the thinner outer sheet T3 and adjacent thicker inner sheet T2.

The present disclosure addresses the current density drop of the current process by applying a layer of ASM between at least two sheets of steel for steel stack-ups in which a thickness ratio between any two adjacent sheets of steel is greater than or equal to 3, with no layer of ASM between a thinner outer sheet and an adjacent thicker inner sheet, thereby using the extra heat generated at the interface of thicker inner sheets to help grow the WN such that it penetrates the thinner outer sheet.

FIG. 1B illustrates a process for resistance welding of steel stack-ups according to an embodiment of the present disclosure. As illustrated in FIG. 1B, the process according to the present disclosure places the layer of ASM between thicker sheets of steel T1 and T2, with no layer of ASM between thinner sheet T3 and adjacent thicker sheet T2. The resulting WN extends deeply enough to penetrate thinner sheet T3.

The present disclosure is applicable when a thickness ratio between any two adjacent sheets of steel is greater than or equal to 3. The layer of ASM, such as at least adhesive, sealer, Al—Si, or any high-resistance weld-through material, enhances the growth of molten metal and fuses faying surfaces when resistance welding steel stack-ups having, for example, thin-thick-thick layers of steel sheets.

The process according to the present disclosure increases weld penetration into a thinner outer sheet of stacked steel sheets having a high-thickness ratio while avoiding the current density drop issue of current processes. The process according to the present disclosure further expands applicability of the process to when a ratio between any two adjacent sheets of steel is greater than or equal to 4.3.

The process of the present disclosure may be performed by a system that includes a robotic dispenser of an ASM, a robotic material handler, a robotic welder and a processing device, such as a processor to control the system. The process may be performed according to a Unified Weld Schedule (UWS) that utilizes varying current over time to attain varying weld forces via controlled heat input.

The present disclosure also provides a process to provide multiple welding solutions based on a stack-up thickness ratio of stacked steel sheets. The process according to the present disclosure provides welding solutions based on the stack-up thickness ratio of stacked steel sheets.

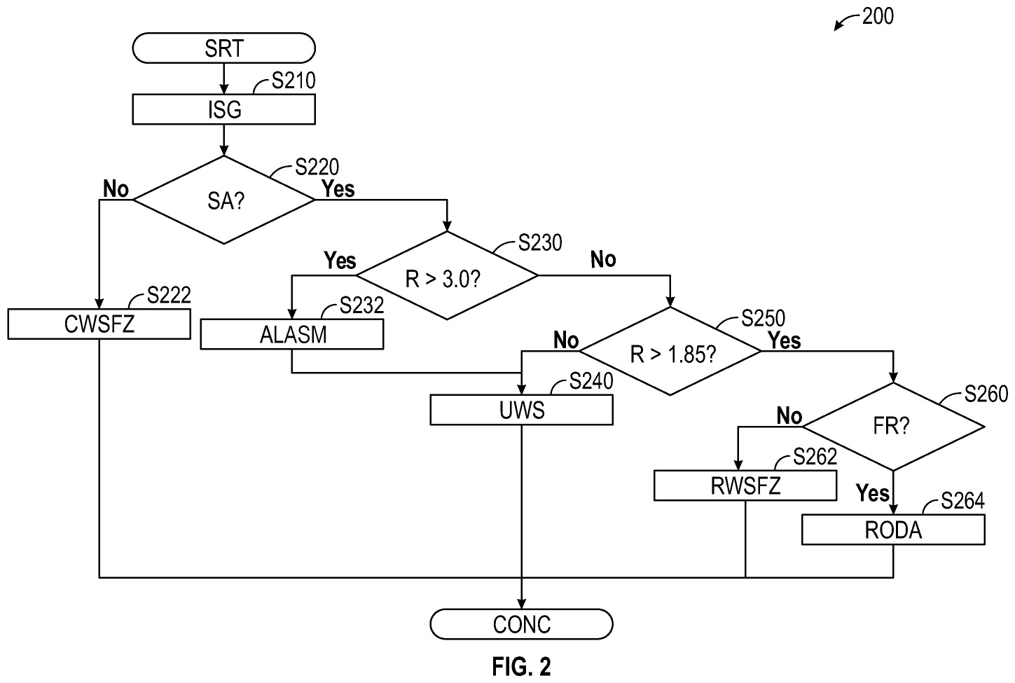

FIG. 2 illustrates a process to determine one of multiple welding solutions based on a thickness ratio of stacked steel sheets according to an embodiment of the present disclosure. As illustrated in FIG. 2, the process 200 Starts (SRT) by inputting a sheet gauge of each sheet (ISG) of the stacked steel sheets at step S210.

At step S220, it is determined if the welded 3T stack is intended for a strategic area weld assembly (SA?), such as a vehicle. If it is determined at step S220 that the welded 3T stack is not intended for a strategic area, the process concludes (CONC) after classifying the weld as a Single Fusion Zone (SFZ), where fusion is only required at the thicker interface (CWSFZ) at step S222. If it is determined at step S220 that the welded 3T stack is intended for a strategic area, the process proceeds to step S230

At step S230, it is determined if a ratio of the thickness of adjacent sheets of the 3T stack is greater than 3.0 (R>3.0?). If it is determined at step S230 that the ratio is greater than 3, the process concludes (CONC) after adding a layer of ASM between adjacent thicker steel sheets of the 3T stack (ALASM) at step S232 and welding the sheets of the 3T stack as loose sheets according to a UWS at step S240. If it is determined at step S230 that that the ratio is not greater than 3, the process proceeds to step S250.

At step S250, it is determined if a ratio of a thickness of the outermost sheets of the 3T stack is greater than 1.85 (R>1.85?). If it is determined at step S250 that the ratio is not greater than 1.85, the process concludes (CONC) after welding the sheets of the 3T stack as loose sheets according to a UWS at step S240. If it is determined at step S250 that that the ratio is greater than 1.85, the process proceeds to step S260.

At step S260, it is determined if fusion is required between the thin outer layer and the adjacent thicker layer of the 3T stack (FR?). If it is determined at step S260 that fusion is not required, the process concludes (CONC) after re-classifying the weld as SFZ (RWSFZ) at step S262. If it is determined at step S260 that fusion is required, the process concludes (CONC) after either a redesign or a deviation is approved (RODA) at step S264.

The present disclosure provides an improved process for welding 3T steel stack-ups that addresses challenges of current processes related to insufficient penetration of a weld into a thinner outer sheet of steel due to current density drop introduced by an ASM between the thinner outer sheet and adjacent thicker inner sheet. By placing the ASM between at least two adjacent thicker inner steel sheets, the weld structure according to the present disclosure extends deeply enough to penetrate a thinner outer sheet of steel. The present disclosure further provides a process to determine one of multiple welding solutions based on a stack-up thickness ratio of stacked steel sheets.

The detailed disclosure and the drawings are supportive and descriptive of the present disclosure, but the scope of the present disclosure is defined solely by the appended claims. While some of the best modes and other embodiments for carrying out the present disclosure have been disclosed in detail, various alternative designs and embodiments exist for practicing the present disclosure as recited in the appended claims. Moreover, the present disclosure expressly includes combinations and sub-combinations of the elements and features disclosed herein.

Aspects of the present disclosure have been presented in general terms and in detail with reference to the illustrated embodiments. Various modifications may be made by those skilled in the art without departing from the scope and spirit of the disclosed embodiments. One skilled in the relevant art will also recognize that the disclosed methods and supporting hardware implementations may be alternatively embodied in other specific forms without departing from the scope of the present disclosure. Therefore, the present disclosure is intended to be illustrative without limiting the inventive scope defined solely by the appended claims.

What is claimed is:

1. A method for resistance welding at least three steel sheets, each having a corresponding thickness, the method comprising:
arranging the at least three steel sheets as a stack according to the corresponding thickness of each of the at least three steel sheets such that a thinnest of the at least three steel sheets is an outermost layer of the stack;
placing a layer of adhesive/sealer material (ASM) between at least a thickest two steel sheets of the stack; and
resistance welding the stack according to a unified weld schedule (UWS) such that weld penetration extends into the thinnest of the at least three steel sheets.

2. The method of claim 1, wherein the method is performed if a ratio of the corresponding thickness of any two adjacent steel sheets of the stack is at least 4.3.

3. The method of claim 1, wherein the layer of ASM is at least adhesive, sealer, or high resistivity metallic coating.

4. The method of claim 3, wherein the layer of ASM is a combination of at least two of adhesive, sealer, and Al—Si.

5. The method of claim 1, wherein the layer of ASM is placed between more than the thickest two steel sheets of the stack.

6. The method of claim 1, wherein the weld penetration comprises a weld nugget that has a martensitic microstructure zone.

7. The method of claim 1, wherein the method is performed by a system comprising at least:
a robotic dispenser configured to dispense the ASM;
a robotic material handler configured to arrange the at least three steel sheets;
a robotic welder configured to resistance weld the stack; and
a processor configured to control the system.

8. A weld structure produced by resistance welding at least three steel sheets according to a unified weld schedule, each of the at least three steel sheets having a corresponding thickness, the weld structure comprising:
the at least three steel sheets arranged as a stack according to the corresponding thickness of each of the at least three steel sheets such that a thinnest of the at least three steel sheets is a bottom layer of the stack; and
a layer of adhesive/sealer material (ASM) between at least a thickest two steel sheets of the stack,
wherein weld penetration extends into the thinnest of the at least three steel sheets.

9. The weld structure of claim 8, wherein a ratio of the corresponding thickness of any two adjacent steel sheets of the stack is at least 4.3.

10. The weld structure of claim 8, wherein the layer of ASM is at least adhesive, sealer, or high resistivity metallic coating.

11. The weld structure of claim 10, wherein the layer of ASM is a combination of at least two of adhesive, sealer, and Al—Si.

12. The weld structure of claim 8, wherein the layer of ASM is between more than the thickest two steel sheets of the stack.

13. The weld structure of claim 8, wherein the weld penetration comprises a weld nugget that has a martensitic microstructure zone.

14. A method for determining weldability solutions when resistance welding at least three steel sheets in a stack, each of the at least three steel sheets having a corresponding thickness, the method comprising:
determining a thickness of each of the at least three steel sheets;
utilizing a first process if the weld is intended for a strategic area of a welded assembly and a ratio of the corresponding thickness of any two adjacent steel sheets is greater than 3.0;
utilizing a second process if the weld is intended for a strategic area of a physical structure and a ratio of the corresponding thickness of any two adjacent steel sheets is not greater than 3.0 and a ratio of the corresponding thickness of a thickest and a thinnest of the steel sheets is not greater than 1.85;
utilizing a third process if the weld is intended for a strategic area of a welded assembly and a ratio of the corresponding thickness of any two adjacent steel sheets is not greater than 3.0 and a ratio of the corresponding thickness of a thickest and a thinnest of the steel sheets is greater than 1.85 and fusion is required at an interface between each of the steel sheets of the stack that are not the thinnest;
utilizing the third process if the weld is not intended for a strategic area of a welded assembly; and
utilizing a fourth process if the weld is intended for a strategic area of a welded assembly and a ratio of the corresponding thickness of any two adjacent steel sheets is not greater than 3.0 and a ratio of the corresponding thickness of a thickest and a thinnest of the steel sheets is greater than 1.85 but fusion is not necessary at an interface between each of the steel sheets of the stack that are not the thinnest, wherein:
the first process comprises arranging the at least three steel sheets as the stack according to the corresponding thickness of each of the at least three steel sheets such that a thinnest of the at least three steel sheets is an outermost layer of the stack, placing a layer of adhesive/sealer material (ASM) between at least a thickest two steel sheets of the stack and resistance welding the stack according to a unified weld schedule (UWS) such that weld penetration extends into the thinnest of the at least three steel sheets;
the second process comprises welding the stack according to the UWS;
the third process comprises classifying the weld as a Single Fusion Zone (SFZ); and
the fourth process comprises welding the stack according to a redesigned process or seeking approval to weld the stack according to the first process, the second process or the third process.

15. The method of claim 14, further comprising utilizing a first process if the weld is intended for a strategic area of a welded assembly and the ratio of the corresponding thickness of any two adjacent steel sheets of the stack is at least 4.3.

16. The method of claim 14, wherein the layer of ASM is at least adhesive, sealer, or high resistivity metallic coating.

17. The method of claim 16, wherein the layer of ASM is a combination of at least two of adhesive, sealer, and Al—Si.

18. The method of claim 14, wherein the layer of ASM is placed between more than the thickest two steel sheets of the stack.

19. The method of claim 14, wherein the weld penetration comprises a weld nugget that has a martensitic microstructure zone.

20. The method of claim 14, wherein the first process is performed by a system comprising at least:
a robotic dispenser configured to dispense the ASM;
a robotic material handler configured to arrange the at least three steel sheets;
a robotic welder configured to resistance weld the stack; and
a processor configured to control the system.
